(19) United States
(12) Patent Application Publication
(10) Pub. No.: US 2020/0114761 A1
(43) Pub. Date: Apr. 16, 2020

(54) TUNNEL ACCIDENT DETECTION

(71) Applicant: Ford Global Technologies, LLC, Dearborn, MI (US)

(72) Inventors: Oswaldo PEREZ BARRERA, Texcoco (MX); Alvaro JIMENEZ HERNANDEZ, Mexico City (MX)

(21) Appl. No.: 16/603,878

(22) PCT Filed: Apr. 13, 2017
(86) PCT No.: PCT/US2017/027329

§ 371 Date: Oct. 9, 2019

(51) Int. Cl. B60K 28/14; G08G 1/01; G08B 21/02

(52) U.S. Cl. CPC B60K 28/14; G08B 25/08; G08B 21/02; G08G 1/0112

(57) ABSTRACT

A computer includes a memory and a processor programmed to execute instructions stored in the memory. The instructions include estimating a target time defined as an amount of time a vehicle will be in a tunnel, determining that the target time has elapsed, and sending an emergency notification as a result of determining that the vehicle has not exited the tunnel before the target time elapsed.

### BACKGROUND

Telematics sometimes refers to the concept of incorporating telecommunications technology into automobiles. Telematics, therefore, allow the automobile to communicate with satellites, remote servers, and possibly other vehicles. Thus, telematics may help implement satellite navigation, vehicle tracking, emergency communications, etc., in automobiles.

### BRIEF DESCRIPTION OF THE DRAWINGS

FIG. 1 illustrates an example vehicle in communication with a server for detecting potential accidents in a tunnel.

FIG. 2 is a block diagram illustrating example components of the vehicle and of the server.

FIG. 3 is a flowchart of an example process that may be executed by the server to detect vehicle accidents in a tunnel.

### DETAILED DESCRIPTION

Certain telecommunications are inhibited by tunnels. While in a tunnel, the vehicle may lose its ability to wirelessly communicate with anything outside the tunnel. This could disrupt satellite and terrestrial radio, navigation, traffic data, cellular communications, or the like.

Communication disruptions caused by tunnels also make it difficult to report accidents that occur inside the tunnel. The people closest to the accident may not have sufficient signal strength to call emergency services. This means that someone outside the tunnel, or near the entrance or exit to the tunnel, with a stronger communication signal needs to call emergency services. It may take time for someone aware of the accident to get to a location with sufficient signal strength to call emergency services, especially if the tunnel is several miles long. Thus, simply reporting the accident can take quite some time.

One solution includes a computer, in a remote server, that monitors vehicles entering and exiting the tunnel and determines, from the amount of time the vehicle is in the tunnel given the length of the tunnel and the traffic conditions, whether an accident may have occurred inside the tunnel. An example of such a computer includes a memory and a processor programmed to execute instructions stored in the memory. The instructions include estimating a target time defined as an amount of time a vehicle will be in a tunnel, determining that the target time has elapsed, and sending an emergency notification as a result of determining that the vehicle has not exited the tunnel before the target time elapsed.

The target time may be estimated based at least in part on a length of the tunnel and one of a vehicle speed and a posted speed limit. Alternatively or in addition, the target time may be estimated based at least in part on a traffic factor based on a predicted amount of traffic in the tunnel. In this instance, the instructions may further include selecting the traffic factor based on the predicted amount of traffic in the tunnel. Selecting the traffic factor may include querying a database.

In one possible implementation, determining that the target time has elapsed includes determining that the vehicle has arrived at the tunnel, periodically incrementing a time value, and comparing the time value to the target time. Determining that the target time has elapsed may include determining that the target time has elapsed as a result of determining that the time value is equal to or greater than the target time. The instructions may further include commanding a timer to start incrementing the time value as a result of determining that the vehicle has arrived at the tunnel. Periodically incrementing the time value may include waiting a unit of time before commanding the timer to increment the time value.

The instructions executed by the processor may further include generating the emergency notification and queuing the emergency notification. Generating the emergency notification may include querying a database for at least one of emergency contact information and emergency service provider information and addressing the emergency notification to at least one of an emergency contact defined by the emergency contact information and an emergency service provider defined by the emergency service provider information.

In another possible approach, the instructions include estimating a target time defined as an amount of time a vehicle will be in a tunnel, queuing an emergency notification, detecting that the vehicle has exited the tunnel before the target time has elapsed, and deleting the emergency notification from the queue as a result of determining that the vehicle has exited the tunnel before the target time elapsed.

In this approach, the target time may be estimated based at least in part on a length of the tunnel and one of a vehicle speed and a posted speed limit. Also or alternatively, the target time may be estimated based at least in part on a traffic factor based on a predicted amount of traffic in the tunnel. In that instance, instructions may further include selecting the traffic factor based on the predicted amount of traffic in the tunnel. Selecting the traffic factor may include querying a database.

Detecting that the vehicle has exited the tunnel before the target time has elapsed may include includes instructions for reestablishing communication with the vehicle before the target time has elapsed.

In some possible approaches, the instructions may further include generating the emergency notification by querying a database for at least one of emergency contact information and emergency service provider information and addressing the emergency notification to at least one of an emergency contact defined by the emergency contact information and an emergency service provider defined by the emergency service provider information.

An example method includes estimating a target time defined as an amount of time a vehicle will be in a tunnel, determining that the target time has elapsed, and sending an emergency notification as a result of determining that the vehicle has not exited the tunnel before the target time elapsed.

In the method, the target time may be estimated based at least in part on a traffic factor based on a predicted amount of traffic in the tunnel. Determining that the target time has elapsed may include determining that the vehicle has arrived at the tunnel, commanding a timer to begin incrementing a time value, comparing the time value to the target time to determine if the time value is equal to or greater than the target time, and determining that the target time has elapsed as a result of determining that the time value is equal to or greater than the target time.

In some instances, the method may further include generating the emergency notification by querying a database for at least one of emergency contact information and emergency service provider information and addressing the emergency notification to at least one of an emergency contact defined by the emergency contact information and an emergency service provider defined by the emergency service provider information and queuing the emergency notification for sending to at least one of the emergency contact and the emergency service provider.

The elements shown may take many different forms and include multiple and/or alternate components and facilities. The example components illustrated are not intended to be limiting. Indeed, additional or alternative components and/or implementations may be used. Further, the elements shown are not necessarily drawn to scale unless explicitly stated as such.

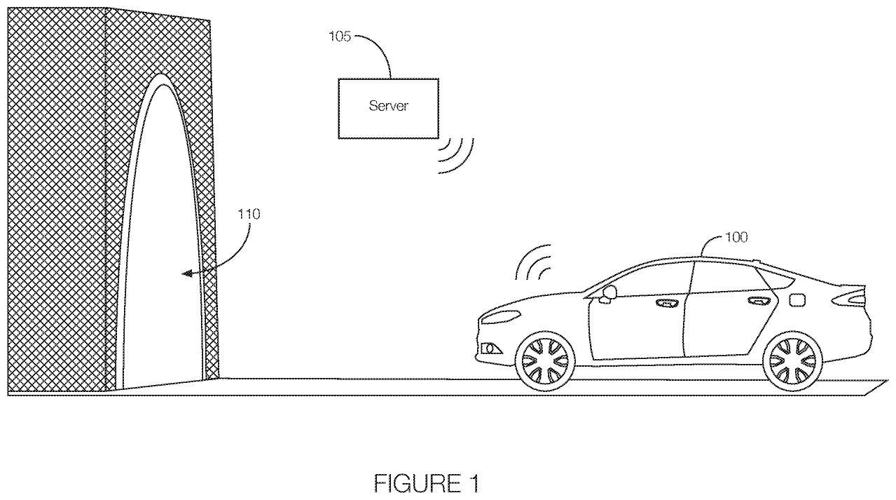

As illustrated in FIG. 1, a target vehicle 100 communicates with a server 105 prior to entering a tunnel 110. Although illustrated as a sedan, the target vehicle 100 may include any passenger or commercial automobile such as a car, a truck, a sport utility vehicle, a crossover vehicle, a van, a minivan, a taxi, a bus, etc. The target vehicle 100 sends a message to the server 105 when the target vehicle 100 is approaching a tunnel 110. In some instances, the target vehicle 100 reports information to the server 105, and the information may include the length of the tunnel 110, traffic data (i.e., traffic congestion, the speed limit, etc.), the present vehicle speed, an expected vehicle speed, or the like.

The server 105 is a computer implemented via circuits, chips, or other electronic components that detects when the target vehicle 100 is about to enter the tunnel 110 and estimates an amount of time (e.g., a “target time”) the target vehicle 100 is expected to be in the tunnel 110. The server 105 sends an emergency notification to an emergency service provider or to an emergency contact person as a result of determining that the target time has elapsed before the target vehicle 100 exits the tunnel 110. An example of an emergency service provider may include the police or emergency medical provider. Examples of an emergency contact may include a family member or friend designated by the owner of the target vehicle 100. The server 105 does not send the emergency notification if the target vehicle 100 emerges from the tunnel 110 before the target time elapses.

The server 105 may detect that the target vehicle 100 is about to enter the tunnel 110 based on communications with the target vehicle 100. That is, the server 105 may determine that the target vehicle 100 is about to enter the tunnel 110 in response to a signal, from the target vehicle 100, indicating as much. Alternatively or in addition, the server 105 may track the target vehicle 100 by, e.g., processing location data sent from the target vehicle 100 to the server 105. The server 105 may determine that the target vehicle 100 is about to enter the tunnel 110 based on the location data.

The server 105 estimates the target time based on, e.g., the length of the tunnel 110, the actual vehicle speed, an estimated vehicle speed, traffic data, or any combination of these or other factors. The server 105 may determine some or all of these factors. In some instances, one or more factors for estimating the target time is transmitted to the server 105 from the target vehicle 100. In estimating the target time, the server 105 may estimate the target time in accordance with a traffic factor (which may be part of or derived from the traffic data). The traffic factor may allow the server 105 to account for traffic congestion inside the tunnel 110. The traffic factor is discussed in greater detail below.

To determine if the target vehicle 100 has been in the tunnel 110 for longer than the target time, the server 105 may begin marking time (i.e., incrementing a time value) when the target vehicle 100 enters the tunnel 110. The server 105 may compare the amount of time that has elapsed to the target time. The server 105 may determine that the target time has elapsed when the time value exceeds the target time. When the time value exceeds the target time, the server 105 sends the emergency notification to a local emergency service provider, an emergency contact, or both, using a wired or wireless telecommunication protocol.

The server 105 may determine that the target vehicle 100 has exited the tunnel 110 from, e.g., signals transmitted from the target vehicle 100. That is, when the target vehicle 100 exits the tunnel 110, it may send a signal to the server 105 indicating as much. In response to receiving such a signal, the server 105 may cancel or delete any queued emergency notifications for that target vehicle 100.

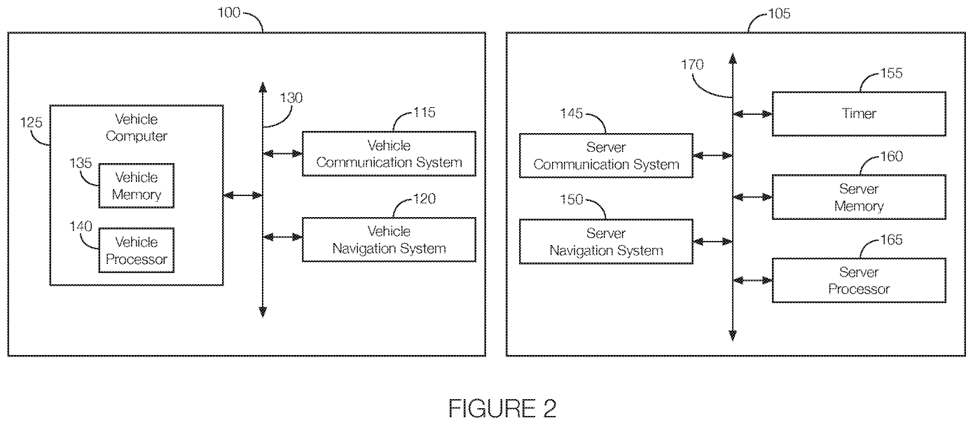

FIG. 2 illustrates example components of the target vehicle 100 and of the server 105. The components of the target vehicle 100 shown in FIG. 2 include a vehicle communication system 115, a vehicle navigation system 120, and a vehicle computer 125. These components may be in communication with one another over a vehicle communication network 130. The vehicle communication network 130 includes hardware, such as a communication bus, for facilitating communication among vehicle components. The vehicle communication network 130 may facilitate wired or wireless communication among the vehicle components in accordance with a number of communication protocols such as controller area network (CAN), Ethernet, WiFi, Local Interconnect Network (LIN), and/or other wired or wireless protocols.

The vehicle communication system 115 is implemented via an antenna, circuits, chips, or other electronic components that facilitate wireless communication between the target vehicle 100 and the server 105. That is, the vehicle communication system 115 may be programmed to receive messages transmitted from the server 105, transmit messages to the server 105, or the like. The messages transmitted to the server 105 may indicate that the target vehicle 100 is about to enter a tunnel 110, that the target vehicle 100 has exited the tunnel 110, the length of the tunnel 110, traffic data, location information, the traffic factor discussed above, emergency contact information, etc. The vehicle communication system 115 may be programmed to communicate in accordance with any number of wired or wireless communication protocols. For instance, the vehicle communication system 115 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, WiFi, the Local Interconnect Network (LIN) protocol, etc. In some instances, the vehicle communication system 115 is incorporated into a vehicle telematics unit.

The vehicle navigation system 120 is implemented via circuits, chips, or other electronic components that can determine a present location of the target vehicle 100. The vehicle navigation system 120 may be implemented via satellite-based system such as the Global Positioning System (GPS). The vehicle navigation system 120 may triangulate the location of the target vehicle 100 based on signals received from various satellites in the Earth's orbit. The vehicle navigation system 120 is programmed to output signals representing the present location of the target vehicle 100 to, e.g., the vehicle computer 125 via the vehicle communication network 130. In some instances, the vehicle navigation system 120 is programmed to determine a route from the present location of the target vehicle 100 to a future location. The vehicle navigation system 120 may access a virtual map stored in the memory (discussed below) and develop the route according to the virtual map data. Further, the vehicle navigation system 120 may identify one or more tunnel 110s along the route, and the vehicle computer 125 may use such information to determine that the target vehicle 100 is about to enter the tunnel 110.

The vehicle computer 125 includes a vehicle memory 135 and a vehicle processor 140. The vehicle memory 135 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The vehicle memory 135 may store instructions executable by the vehicle processor 140 and data such as the vehicle location, traffic data, emergency contact information, data used by the vehicle navigation system 120, or the like. The instructions and data stored in the vehicle memory 135 may be accessible to the vehicle processor 140 and possibly other components of the target vehicle 100.

The vehicle processor 140 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The vehicle processor 140 executes the instructions stored in the vehicle memory 135 and is programmed to access data stored in the vehicle memory 135 and receive signals from other components of the target vehicle 100 such as the vehicle communication system 115, the vehicle navigation system 120, etc. The vehicle processor 140 may be programmed to process the data received or accessed. For instance, the vehicle processor 140 may be programmed to receive and process location information output by the navigation system, determine, from the location information, when the target vehicle 100 is about to enter a tunnel 110 from the location information, determine that the target vehicle 100 has exited the tunnel 110 from the location information, and command the vehicle communication system 115 to communicate with the server 105.

The vehicle processor 140 may command the vehicle communication system 115 to transmit data to the server 105. The data transmitted to the server 105 may include the location information, traffic data, the length of the tunnel 110, the traffic factor, the vehicle speed, the emergency contact information, etc. The vehicle processor 140 may command the vehicle communication system 115 to wirelessly transmit that or other data to the server 105 some predetermined time or distance (e.g., on the order of 30 seconds or half a mile, respectively) before the target vehicle 100 enters the tunnel 110.

While in the tunnel 110, the vehicle processor 140 may periodically determine whether the target vehicle 100 has exited the tunnel 110. The navigation system may lose connectivity while in the tunnel 110 so one way for the vehicle processor 140 to determine if the target vehicle 100 is still in the tunnel 110 is for the vehicle processor 140 to determine if the navigation system is able to determine the location of the target vehicle 100. If not, the vehicle processor 140 may conclude that the target vehicle 100 is still in the tunnel 110. Similarly, the vehicle processor 140 may conclude that the target vehicle 100 is still in the tunnel 110 if the navigation system is unable to communicate with, e.g., any remote satellites. Further, in some instances, the vehicle processor 140 may command the vehicle communication system 115 to periodically send a signal to the server 105. The vehicle processor 140 may determine that the target vehicle 100 is still in the tunnel 110 if no response is received from the server 105 within a predetermined period of time (e.g., on the order of a few seconds). In other words, the vehicle processor 140 may determine that the target vehicle 100 is still in the tunnel 110 if the signal to the server 105 times out before the vehicle communication system 115 receives a response from the server 105.

When the vehicle processor 140 determines that the target vehicle 100 has exited the tunnel 110, the vehicle processor 140 may command the vehicle communication system 115 to transmit the signal to the server 105 indicating that the target vehicle 100 has exited the tunnel 110. Alternatively, in implementations where the vehicle processor 140 periodically commands the vehicle communication system 115 to transmit the signal, the vehicle processor 140 may command the vehicle communication system 115 to stop attempting to contact the server 105 once, e.g., the server 105 responds to the signal since that would indicate that the target vehicle 100 is no longer in the tunnel 110 and that the server 105 has acknowledged as much from the target vehicle 100.

The components of the server 105 shown in FIG. 2 include a server communication system 145, a server navigation system 150, a timer 155, a server memory 160, and a server processor 165. The components of the server 105 may communicate with one another via, a server communication network 170. The server communication network 170 includes hardware, such as a communication bus, for facilitating communication among the components of the server 105. The server communication network 170 may facilitate wired or wireless communication among the components of the server 105 in accordance with a number of communication protocols such as controller area network (CAN), Ethernet, WiFi, Local Interconnect Network (LIN), and/or other wired or wireless protocols.

The server communication system 145 is implemented via an antenna, circuits, chips, or other electronic components that facilitate wired or wireless communication between the target vehicle 100 and the server 105, between the server 105 and an emergency service provider, between the server 105 and an emergency contact associated with the target vehicle 100, or a combination thereof. That is, the server communication system 145 may be programmed to receive messages transmitted from the target vehicle 100, transmit messages to the target vehicle 100, or the like. The messages received at the server communication system 145 may indicate that the target vehicle 100 is about to enter a tunnel 110, that the target vehicle 100 has exited the tunnel 110, the length of the tunnel 110, traffic data, location information, the traffic factor discussed above, emergency contact information, etc. The communications between the server communication system 145 and the emergency service provider or emergency contact may include a message indicating that the target vehicle 100 did not emerge from the tunnel 110 as expected, which may indicate that an accident has occurred in the tunnel 110. The server communication system 145 may be programmed to communicate in accordance with any number of wired or wireless communication protocols. For instance, the server communication system 145 may be programmed to communicate in accordance with a satellite-communication protocol, a cellular-based communication protocol (LTE, 3G, etc.), Bluetooth®, Bluetooth® Low Energy, Ethernet, the Controller Area Network (CAN) protocol, WiFi, the Local Interconnect Network (LIN) protocol, etc.

The server navigation system 150 is implemented via circuits, chips, or other electronic components that can determine a present location of the target vehicle 100 based on, e.g., location information received from the target vehicle 100. The location information received at the server navigation system 150 may include coordinates of the target vehicle 100, a direction of the target vehicle 100, a speed of the target vehicle 100, etc. The server navigation system 150 may use such information to determine that the target vehicle 100 is about to enter a tunnel 110. That is, the server navigation system 150 may access a virtual map stored in the server memory 160 (discussed below) and, from the virtual map data and the location information, identify tunnel 110s in the path of the target vehicle 100, determine if the target vehicle 100 is about to enter a tunnel 110, and determine the length of the tunnel 110 that the target vehicle 100 is about to enter. In some possible implementations, the server navigation system 150 may determine that the target vehicle 100 is about to enter the tunnel 110, and possibly the length of the tunnel 110, based on signals indicating as much transmitted from the target vehicle 100, as discussed above.

The timer 155 is implemented via circuits, chips, or other electronic components that mark the passage of time. For instance, upon a command from the server processor 165, the timer 155 may be configured or programmed to being marking time by incrementing a time value. The timer 155 may periodically output the time value to the server processor 165. If the timer 155 begins marking time when the target vehicle 100 enters the tunnel 110, the time value will represent the amount of time that has elapsed since the target vehicle 100 entered the tunnel 110. If the timer 155 stops marking time when the target vehicle 100 exits the tunnel 110, the time value will represent the amount of time the target vehicle 100 was in the tunnel 110. The timer 155 is programmed or configured to begin and end marking time in accordance with control signals received from the server processor 165. Further, although shown as a separate component, the timer 155 may be incorporated into the server processor 165 or another component of the server 105.

The server memory 160 is implemented via circuits, chips or other electronic components and can include one or more of read only memory (ROM), random access memory (RAM), flash memory, electrically programmable memory (EPROM), electrically programmable and erasable memory (EEPROM), embedded MultiMediaCard (eMMC), a hard drive, or any volatile or non-volatile media etc. The server memory 160 may store instructions executable by the server processor 165 and data such as the vehicle location, traffic data, emergency contact information, data used by the server navigation system 150, or the like. The instructions and data stored in the server memory 160 may be accessible to the server processor 165 and possibly other components of the server 105.

The server processor 165 is implemented via circuits, chips, or other electronic component and may include one or more microcontrollers, one or more field programmable gate arrays (FPGAs), one or more application specific integrated circuits (ASICs), one or more digital signal processors (DSPs), one or more customer specific integrated circuits, etc. The server processor 165 executes the instructions stored in the server memory 160 and is programmed to access data stored in the server memory 160 and receive signals from other components of the target vehicle 100 such as the server communication system 145, the server navigation system 150, etc. The server processor 165 may be programmed to process the data received or accessed. For instance, the server processor 165 may be programmed to detect when the target vehicle 100 is about to enter the tunnel 110 and estimate the target time, which as discussed above is the amount of time the target vehicle 100 is expected to be in the tunnel 110. The server processor 165 is further programmed to send an emergency notification to an emergency service provider or to an emergency contact person as a result of determining that the target time has elapsed before the target vehicle 100 has exited the tunnel 110. The server processor 165 is further programmed to not send the emergency notification if the target vehicle 100 emerges from the tunnel 110 before the target time elapses.

The server processor 165 may be programmed to detect that the target vehicle 100 is about to enter the tunnel 110 based on communications with the target vehicle 100. That is, the server processor 165 may be programmed to determine that the target vehicle 100 is about to enter the tunnel 110 in response to a signal, from the target vehicle 100, indicating as much. The signal may be received via the server communication system 145 and transmitted to the server processor 165 over the server communication network 170. Alternatively or in addition, the server processor 165 may be programmed to track the target vehicle 100 by, e.g., processing location data sent from the target vehicle 100 to the server 105. The location data may be received at the server 105 by the server communication system 145 and transmitted to the server processor 165 over the server communication network 170. The server processor 165 may be programmed to determine that the target vehicle 100 is about to enter the tunnel 110 based on the location data.

The server processor 165 may be programmed to estimate the target time based on, e.g., the length of the tunnel 110, the actual vehicle speed, an estimated vehicle speed, traffic data (including a posted speed limit), or any combination of these or other factors. For example, the target time may be equal to the length of the tunnel 110 divided by the actual or predicted vehicle speed or divided by the speed limit. The server processor 165 may be programmed to determine some or all of these factors. In some instances, one or more factors for estimating the target time may be transmitted to the server processor 165 from the vehicle communication system 115 by way of the server communication system 145 and the server communication network 170.

In estimating the target time, the server processor 165 may be programmed to estimate the target time in accordance with a traffic factor (which may be part of or derived from the traffic data). The traffic factor may allow the server processor 165 to account for traffic congestion inside the tunnel 110. The traffic factor may be a variable representing the amount of traffic in or near the tunnel 110 at the time the target vehicle 100 is about to enter the tunnel 110.

In some instances, the traffic factor may be a constant that replaces the vehicle speed or speed limit in calculating the target time. Thus, in this example, the target time may be defined as the length of the tunnel 110 divided by the traffic factor. Examples of traffic factors may include a value between or including 0.5-2 mph for a high amount of traffic expected in the tunnel 110, a value between or including 8-12 mph for a moderate amount of traffic expected in the tunnel 110, or a value between or including 15-20 mph for a low amount of traffic expected in the tunnel 110. For instance, traffic factors of 0.5 mph, 9 mph, and 18 mph, representing high, moderate, and low traffic, respectively, may be used as the “vehicle speed” in the target time equation instead of an actual vehicle speed. Moreover, the traffic factor, when replacing the vehicle speed in the target time equation, may be lower than the actual expected vehicle speed to give the target vehicle 100 additional time to travel through the tunnel 110, thereby minimizing false positives.

Another option is that the traffic factor may be a multiple applied to the result of dividing the tunnel 110 length by the vehicle speed or speed limit. The multiple may be related to or independent of the expected amount of traffic in the tunnel 110. Examples of traffic factors under this scenario could include numbers like 1.2, 1.5, 2.0, 2.5, 5.0, etc., applied by the server processor 165 after dividing the length of the tunnel 110 by the vehicle speed or speed limit. Thus, if the length of the tunnel 110 divided by the vehicle speed or speed limit indicates that it will take the target vehicle 100 15 minutes to travel through the tunnel 110, the server processor 165 may calculate the target time of 22.5 minutes (22 minutes and 30 seconds) after applying the traffic factor of 1.5.

The server processor 165 may select the traffic factor according to the amount of traffic expected in the tunnel 110. For instance, a value of 1.5 may be selected if low traffic is expected, a value of 2.5 may be selected if moderate traffic is expected, and a value of 5.0 may be selected if high traffic is expected. These numbers may all be greater than one to give the target vehicle 100 additional time to travel through the tunnel 110 to, e.g., prevent or minimize false positives.

In instances where the server processor 165 selects from among multiple traffic factors, the possible traffic factors may be stored in a database in the server memory 160. The database may relate traffic factors to different expected amounts of traffic congestion in the tunnel 110. The server processor 165 may be programmed to query the database for the appropriate traffic factor given the expected amount of traffic in the tunnel 110. Thus, the target time calculated by the server processor 165 may account for the traffic factor.

To determine if the target vehicle 100 has been in the tunnel 110 for longer than the target time, the server processor 165 may be programmed to command the timer 155 to begin marking time (i.e., incrementing a time value) when the target vehicle 100 enters the tunnel 110. The server processor 165 may determine that the target vehicle 100 has entered or is about to enter the tunnel 110 based on a signal received from the target vehicle 100 received via the server communication system 145 or by calculating when the target vehicle 100 has entered the tunnel 110 based on, e.g., location data and the vehicle speed transmitted from the target vehicle 100 and received via the server communication system 145. The server processor 165 may be programmed to receive the time value from the timer 155 and compare the amount of time value to the target time. The server processor 165 may be programmed to determine that the target time has elapsed when the time value exceeds the target time. When the time value exceeds the target time, the server processor 165 commands the server communication system 145 to send the emergency notification to a local emergency service provider, an emergency contact, or both, using a wired or wireless telecommunication protocol. The server processor 165 may retrieve contact information for the emergency service provider, the emergency contact, or both, from, e.g., a database stored in the server memory 160. The server processor 165 may be programmed to queue an emergency notification while the timer 155 is running.

The server processor 165 may be programmed to determine that the target vehicle 100 has exited the tunnel 110 from, e.g., signals transmitted from the target vehicle 100. That is, when the target vehicle 100 exits the tunnel 110, the vehicle communication system 115 may send a signal to the server communication system 145 indicating that the target vehicle 100 has exited the tunnel 110. The server communication system 145 may transmit the signal to the server processor 165. In response to receiving such a signal, the server processor 165 may be programmed to cancel or delete any queued emergency notifications for the target vehicle 100.

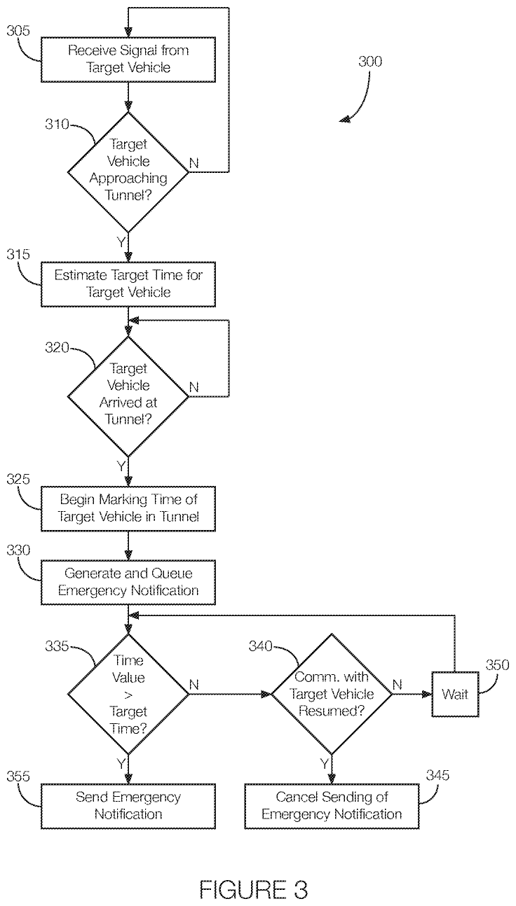

FIG. 3 is a flowchart of an example process 300 that may be executed by the server 105 to detect vehicle accidents in a tunnel 110.

At block 305, the server 105 receives signals from a target vehicle 100. The server communication system 145 may receive signals from the vehicle communication system 115. The server communication system 145 may receive, e.g., location information, traffic data, a tunnel 110 length, etc., from the vehicle communication system 115. Additional data received from the data may include, e.g., emergency contact information. In some instances, the server communication system 145 may receive a signal from the vehicle communication system 115 indicating that the target vehicle 100 is about to enter a tunnel 110. Data received from the target vehicle 100 may be transmitted from the server communication system 145 to the server processor 165.

At decision block 310, the server 105 determines whether the target vehicle 100 is about to enter a tunnel 110. The server processor 165 may detect that the target vehicle 100 is about to enter the tunnel 110 based on the data received from the target vehicle 100, which the server processor 165 may process to track the target vehicle 100, or from the signal indicating that the target vehicle 100 is about to enter the tunnel 110. If the server processor 165 detects that the target vehicle 100 is about to enter the tunnel 110, the process 300 may proceed to block 315. Otherwise, the process 300 may return to block 305 so that the server 105 may gather additional data about the target vehicle 100.

At block 315, the server 105 may estimate the target time, which as discussed above is the amount of time the target vehicle 100 is expected to be in the tunnel 110. The server processor 165 may calculate the target time based on, e.g., the length of the tunnel 110, the actual vehicle speed, an estimated vehicle speed, traffic data (including a posted speed limit), or any combination of these or other factors. For example, the target time may be equal to the length of the tunnel 110 divided by the actual or predicted vehicle speed or divided by the speed limit. In another possible approach, the target time may be calculated from the length of the tunnel 110 divided by the traffic factor. In yet another possible approach, the target time may be a function of the length of the tunnel 110 divided by a vehicle speed and multiplied by the traffic factor. In either instance, the traffic factor may be based on the amount of traffic predicted in the tunnel 110. As such, estimating the target time may include predicting the amount of traffic in the tunnel 110 and selecting the traffic factor in accordance with the predicted amount of traffic. Selecting the traffic factor may include querying a database stored in the server memory 160. Further, the target time may be calculated by the target vehicle 100 and transmitted to the server 105. That is, the vehicle processor 140 may calculate the target time and command the vehicle communication system 115 to transmit the target time to the server 105.

At decision block 320, the server 105 determines if the target vehicle 100 has arrived at the tunnel 110. The server processor 165 may determine that the target vehicle 100 has arrived at the tunnel 110 based on the data received from the target vehicle 100, which the server processor 165 may process to track the target vehicle 100, or from a signal, transmitted to the server 105 from the target vehicle 100, indicating that the target vehicle 100 has arrived at the tunnel 110. If the server processor 165 determines that the target vehicle 100 has arrived at the tunnel 110, the process 300 may proceed to block 325. Otherwise, the process 300 may repeat block 320 so that the server processor 165 may continue to track the target vehicle 100 until the target vehicle 100 arrives at the tunnel 110.

At block 325, the server 105 begins marking the amount of time the target vehicle 100 has been in the tunnel 110. For instance, the server processor 165 may output a command to the timer 155 to start incrementing a time value.

At block 330, the server 105 may generate and queue an emergency notification. The server processor 165 may generate, but not send, the emergency notification and store the emergency notification in the server memory 160 or a transmission queue of the server communication system 145. Generating the emergency notification may include the server processor 165 retrieving emergency contact information, emergency service provider information, or the like from the server memory 160. The server processor 165 may generate the emergency notification in accordance with such information. That is, the server processor 165 may generate the emergency notification addressed to the emergency contact, emergency service provider, or both.

At decision block 335, the server 105 determines if the time value exceeds the target time. That is, the server processor 165 may compare the time value to the target time. If the time value is less than the target time, the process 300 may proceed to block 340. If the time value is equal to or greater than the target time, the process 300 may proceed to block 355.

At decision block 340, the server 105 determines if it has reestablished communication with the target vehicle 100. The server processor 165 may determine that the target vehicle 100 has reestablished communication with the server 105 if the server communication system 145 receives a signal transmitted from the vehicle communication system 115 after the target vehicle 100 entered the tunnel 110. The target vehicle 100 may reestablish communication with the server 105 on its own (e.g., the vehicle processor 140 may be programmed to periodically attempt to reestablish communication with the server 105) or in response to a query from the server 105 (e.g., the server processor 165 may be programmed to periodically ping the target vehicle 100 for a response). To conserve bandwidth, the server processor 165 may be programmed to ping the target vehicle 100 closer to the target time as opposed to the entire time the target vehicle 100 is in the tunnel 110. If the server processor 165 determines that communication with the target vehicle 100 has been reestablished, the process 300 may proceed to block 345. Otherwise, the process 300 may proceed to block 350.

At block 345, the server 105 cancels sending of the emergency notification. Canceling sending of the emergency notification may include the server processor 165 deleting the emergency notification from the server memory 160 or from a transmission queue in the server communication system 145. Alternatively, the process 300 may simply end at block 345 without the server 105 taking any additional action with respect to the target vehicle 100.

At block 350, the server 105 waits a unit of time, such as 1 second, 5 seconds, 10 seconds, 30 seconds, etc. That is, the server processor 165 may wait the unit of time before returning to block 335. Otherwise, the time value may increment with every clock cycle as opposed to every, e.g., 1 second, 5 seconds, 10 seconds, 30 seconds, etc.

At block 355, the server 105 sends the emergency notification. That is, the server processor 165 may command the server communication system 145 to transmit the emergency notification stored in the server memory 160 or in the transmission queue.

The process 300 may end, at least with respect to the target vehicle 100, after block 355.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computer comprising a memory and a processor programmed to execute instructions stored in the memory, the instructions including:
estimating a target time defined as an amount of time a vehicle will be in a tunnel;
determining that the target time has elapsed; and
sending an emergency notification as a result of determining that the vehicle has not exited the tunnel before the target time elapsed.

2. The computer of claim 1, wherein the target time is estimated based at least in part on a length of the tunnel and one of a vehicle speed and a posted speed limit.

3. The computer of claim 1, wherein the target time is estimated based at least in part on a traffic factor based on a predicted amount of traffic in the tunnel.

4. The computer of claim 3, the instructions further including selecting the traffic factor based on the predicted amount of traffic in the tunnel.

5. The computer of claim 4, wherein selecting the traffic factor includes querying a database.

6. The computer of claim 1, wherein determining that the target time has elapsed includes determining that the vehicle has arrived at the tunnel, periodically incrementing a time value, and comparing the time value to the target time.

7. The computer of claim 6, wherein determining that the target time has elapsed includes determining that the target time has elapsed as a result of determining that the time value is equal to or greater than the target time.

8. The computer of claim 6, the instructions further including commanding a timer to start incrementing the time value as a result of determining that the vehicle has arrived at the tunnel and wherein periodically incrementing the time value includes waiting a unit of time before commanding the timer to increment the time value.

9. The computer of claim 1, the instructions further including generating the emergency notification and queuing the emergency notification.

10. The computer of claim 9, wherein generating the emergency notification includes querying a database for at least one of emergency contact information and emergency service provider information and addressing the emergency notification to at least one of an emergency contact defined by the emergency contact information and an emergency service provider defined by the emergency service provider information.

11. A computer comprising a memory and a processor programmed to execute instructions stored in the memory, the instructions including:
estimating a target time defined as an amount of time a vehicle will be in a tunnel;
queuing an emergency notification;
detecting that the vehicle has exited the tunnel before the target time has elapsed; and
deleting the emergency notification from the queue as a result of determining that the vehicle has exited the tunnel before the target time elapsed.

12. The computer of claim 11, wherein the target time is estimated based at least in part on a length of the tunnel and one of a vehicle speed and a posted speed limit.

13. The computer of claim 1, wherein the target time is estimated based at least in part on a traffic factor based on a predicted amount of traffic in the tunnel, and the instructions further including selecting the traffic factor based on the predicted amount of traffic in the tunnel.

14. The computer of claim 13, wherein selecting the traffic factor includes querying a database.

15. The computer of claim 11, wherein detecting that the vehicle has exited the tunnel before the target time has elapsed includes reestablishing communication with the vehicle before the target time has elapsed.

16. The computer of claim 11, the instructions further including generating the emergency notification by querying a database for at least one of emergency contact information and emergency service provider information and addressing the emergency notification to at least one of an emergency contact defined by the emergency contact information and an emergency service provider defined by the emergency service provider information.

17. A method comprising:
estimating a target time defined as an amount of time a vehicle will be in a tunnel;
determining that the target time has elapsed; and
sending an emergency notification as a result of determining that the vehicle has not exited the tunnel before the target time elapsed.

18. The method of claim 17, wherein the target time is estimated based at least in part on a traffic factor based on a predicted amount of traffic in the tunnel.

19. The method of claim 17, wherein determining that the target time has elapsed includes determining that the vehicle has arrived at the tunnel, commanding a timer to begin incrementing a time value, comparing the time value to the target time to determine if the time value is equal to or greater than the target time, and determining that the target time has elapsed as a result of determining that the time value is equal to or greater than the target time.

20. The method of claim 17, further comprising:
generating the emergency notification by querying a database for at least one of emergency contact information and emergency service provider information and addressing the emergency notification to at least one of an emergency contact defined by the emergency contact information and an emergency service provider defined by the emergency service provider information, and
queuing the emergency notification for sending to at least one of the emergency contact and the emergency service provider.
